(19) United States
(12) Patent Application Publication
(10) Pub. No.: US 2025/0207047 A1
(43) Pub. Date: Jun. 26, 2025

(54) FIXED BED GASIFIER WITH TEMPERATURE-HOMOGENIZATION LAYER

(71) Applicant: MHR HOLDING PTE. LTD., Singapur (SG)

(72) Inventors: Michael Hofmeister, Dresden (DE); Horst Dressler, Muehlhausen (DE)

(21) Appl. No.: 18/846,745

(22) PCT Filed: Mar. 2, 2023
(86) PCT No.: PCT/IB2023/051943

§ 371 Date: Sep. 13, 2024

(30) Foreign Application Priority Data
Mar. 16, 2022 (DE) 10 2022 106 172.8

(51) Int. Cl. C10J 3/74

(52) U.S. Cl. CPC C10J 3/74; C10J 2200/15

(57) ABSTRACT

A fixed bed gasifier for generating a producer or synthesis gas from solid fuel, particularly from slagging fuel, includes a gasifier tank, a fuel supply for supplying a solid fuel, and one or more gasification agent supplies for supplying one or more gasification agents used to gasify the solid fuel provided in the tank. An outlet discharges slag and producer gas which result from the gasification of the solid fuel. At least one section of a tank wall of the gasifier tank is surrounded by a temperature homogenizing layer, the heat conductivity of which is higher than the heat conductivity of the gasifier tank and which ensures an even temperature distribution in the tank wall in the axial direction and the circumferential direction of the gasifier tank.

### CROSS-REFERENCE TO RELATED APPLICATIONS

This application is the United States national stage entry of International Application No. PCT/IB2023/051943, filed on Mar. 2, 2023, and claims priority to German Application No. 10 2022 106 172.8, filed on Mar. 16, 2022. The contents of International Application No. PCT/IB2023/051943 and German Application No. 10 2022 106 172.8 are incorporated by reference herein in their entireties.

### FIELD

The present disclosure relates to a fixed bed gasifier for generating a producer or synthesis gas from solid fuel, in particular from slagging fuel, comprising a, specifically cylindrical, gasifier tank. The gasifier tank includes a fuel supply for supplying a solid fuel, a gasification agent supply for supplying a gasification agent which is used to gasify the solid fuel provided in the tank, and an outlet for discharging slag and ash and producer gas which result from the gasification of the solid fuel.

### BACKGROUND

In the fixed bed gasifier, (bulk) fuel, specifically biomass, in a solid state (solid fuel), usually wood or coal, sewage sludge, but also biomass-type and other secondary fuels, as well as a proportion of domestic waste/plastic fractions, is converted thermochemically to a combustible producer or synthesis gas (fuel gas) with the aid of a gasification or oxidation agent, in particular air, oxygen, carbon dioxide or steam. The solid fuel can be converted, via the gasification in the fixed bed gasifier, to a gaseous secondary fuel or to a producer gas which can be used, for example, in electricity generation or as fuel and propellant (fuel gas) or for use as synthesis gas for chemical synthesis.

The fixed bed gasifier or, resp., the gasifier tank is divided into different adjacent temperature zones in its height direction or axial direction, respectively. The temperature zone closest to the opening is a drying zone in which the water contained in the solid fuel is evaporated at a drying temperature. A pyrolysis zone adjoins the drying zone in the height direction below the latter. In the pyrolysis zone, the solid fuel is disintegrated at a pyrolysis temperature. An oxidation zone adjoins the pyrolysis zone in the height direction below the latter. In the oxidation zone, the carbon (C) and hydrogen (H) contained in the disintegrated solid fuel are oxidized into carbon dioxide (CO₂) and, resp., into water (H₂O) at an oxidation temperature. A reduction zone adjoins the oxidation zone in the height direction below the latter. In the reduction zone, the carbon dioxide (CO₂) and, resp., the water (H₂O) obtained from the oxidation zone are reduced at a reduction temperature into the combustible producer or synthesis gas as a product of fixed bed gasification. In the fixed bed gasifier, the drying temperature is lower than the pyrolysis temperature which, in turn, is lower than the oxidation temperature which, in turn, is higher than the reduction temperature. Carbonaceous ash remains as a solid component of the gasified solid fuel.

Furthermore, fixed bed gasifiers can be used to gasify, as a fuel, a slagging fuel or biomass, specifically biological residues, preferably waste materials, further preferably sewage sludge. The gasification of those slagging fuels, specifically of sewage sludge, is used for the environmentally friendly disposal of said materials.

In fixed bed gasification, in particular in cases in which slagging fuels such as waste materials are used as biomass to be gasified, the oxidation temperature differs/varies depending on the material used. Although the oxidation temperature is maintained in a specific range, large temperature gradients occur in the gasifier tank, particularly when the solid bed gasifier is run up and shut down (when the gasification is started and stopped). The temperature gradients (local temperature differences) are present mainly in the height direction or axial direction (along the longitudinal axis of the solid bed gasifier and the gasifier tank, resp.,) as well as in the circumferential direction and possibly also in the radial direction. At temperature gradients larger than a specific limit temperature gradient, the gasifier tank deforms plastically and thus permanently and has to be replaced after a short time. This is not economic.

Heat-resistant materials such as concrete, fire clay or ceramic have a too low resistance to thermal shock to follow the rapid and high temperature changes (temperature differences over time) in those relatively small systems. After a short time, they will break and crumble.

### SUMMARY

Accordingly, it is an object of the present disclosure to provide a solid bed gasifier that achieves the above-described problem. In particular, a solid bed gasifier is intended to be provided whose operation is economic in the long run. Preferably, a solid bed gasifier is to be provided in which large temperature gradients, particularly in the height direction and the circumferential direction and, possibly, in the radial direction of the solid bed gasifier, are avoided.

Consequently, the present disclosure relates to a solid bed gasifier for generating a producer or synthesis gas from solid fuels, in particular from slagging fuels, comprising a, specifically cylindrical, gasifier tank. The gasifier tank includes a fuel supply for supplying a solid fuel, one or more gasification agent supply/supplies for supplying one or more gasification agent(s) which is/are used to gasify the solid fuel provided in the tank, and an outlet for discharging slag, carbonaceous ash and producer and synthesis gas which result from the gasification of the solid fuel. At least one section of a tank wall of the gasifier tank, particularly of a gasifier insert in the gasifier tank, is surrounded by a temperature homogenizing layer whose heat conductivity is (substantially) higher than the heat conductivity of the tank wall and which ensures uniform temperature distribution in the tank wall in the axial direction and the circumferential direction of the gasifier tank.

As the temperature homogenizing layer is arranged on the gasifier tank, particularly in the gasifier insert in which large temperature gradients of 450 K or even more can occur, the temperature is distributed uniformly and homogenously over the tank wall. As the temperature homogenizing layer has a significantly higher heat conductivity than the tank wall, temperature ranges which were different before balance each other out in said temperature homogenizing layer. Accordingly, large temperature gradients of 450 K or even more are avoided. If there are still any temperature gradients at all in the tank wall, they are significantly smaller than 450 K, for example are at most 200 K. Thus, the temperature homogenizing layer can help prevent the tank wall from warping and permanently deforming plastically so that the service life of the gasifier tank, and specifically the gasifier insert, is significantly extended. When the gasifier is frequently run up and shut down, this method guarantees a long-term economic use.

When the fixed bed gasifier is heated, the gasifier tank, specifically the gasifier insert, quickly reaches its operating temperature of about 700° C. to about 900° C. Independently of the operating mode of the fixed bed gasifier according to the disclosure, the temperature is maintained in the operating temperature range of about 700° C. to about 900° C. even if the fixed bed gasifier is stopped. In this process, temperature peaks of 1000-1700° C. may occur at certain points in the bulk material.

Advantageous aspects of the present disclosure will be explained in detail as follows.

Advantageously, the heat conductivity of the temperature homogenizing layer is higher by at least 3.8 times, preferably by at least 9 times, further preferably by at least 19 times, than the heat conductivity of the tank wall.

In the case of those differences in the heat conductivity between the temperature homogenizing layer and the tank wall, it can be ensured that the temperature can be distributed sufficiently evenly over the tank wall.

It can be particularly provided that the tank wall forms an inner casing that encloses, together with an outer casing spaced apart, specifically in the radial direction, from the inner casing, the temperature homogenizing layer, and the heat conductivity of the temperature homogenizing layer is also higher than the heat conductivity of the inner and outer casings. The inner and outer casings preferably form an annular passage in which the temperature homogenizing layer is received.

In the fixed bed gasifier, temperatures of up to 1700° C. can occur. The temperature homogenizing layer can reach up to 1200° C. Accordingly, the melting temperature of the material forming the temperature homogenizing layer may be reached. In order to prevent the molten temperature homogenizing layer from just “flowing off”, it is enclosed by the inner casing and the outer casing and, thus, is retained in the respective section of the tank wall. As the heat conductivity of the inner and outer casings is lower than the heat conductivity of the temperature homogenizing layer, the heat is not dissipated by the gasifier tank. With respect to the energy balance of the fixed bed gasifier, this is positive and ensures that a high efficiency is maintained in the fixed bed gasifier.

The temperature homogenizing layer maintains the inner and outer casings below their melting temperature, although the temperatures in the bulk material may be above the melting temperature of the material of the inner and outer casings.

Preferably, for the tank wall and for the gasifier insert, resp., outer and inner casings are provided whose materials have to be selected so that the melting point thereof is above the maximum temperatures reached in the temperature homogenizing layer, particularly above 1200° C.

In this way, the tank wall and the outer and inner casings of the gasifier insert can be prevented from melting.

It can be of particular advantage when the outer casing and the inner casing are made of the same material. Furthermore, with respect to the gist of the present disclosure, it is very useful when the temperature homogenizing layer is made of a material different from that of the tank wall and, resp., the inner casing and specifically also of the outer casing.

It is desirable when the temperature homogenizing layer is manufactured of a material having a heat conductivity of at least 190 W/mK.

When the temperature homogenizing layer has such heat conductivity, it can be ensured that the temperature can be distributed sufficiently evenly over the tank wall. The higher the heat conductivity of the temperature homogenizing layer, the more even the temperature distribution in the tank wall.

It is further preferred that the solid fuel is gasified in the gasifier tank in different temperature zones successive and, resp., adjacent in the axial direction which include in particular a drying zone, a pyrolysis zone, an oxidation zone and a reduction zone, and the section of the tank wall of the gasifier tank that is surrounded by the temperature homogenizing layer extends at least (in the axial direction) over the area of the different temperature zones.

The largest temperature gradients in the fixed bed gasifier occur in the area of the different temperature zones in the gasifier tank. Consequently, it is particularly useful when the temperature homogenizing layer is provided at this location or in this area, respectively. At this location, the temperature homogenizing layer has the greatest effect on the even temperature distribution in the fixed bed gasifier.

It is also conceivable that the tank wall is manufactured of stainless steel or black steel, preferably stainless steel, and the temperature homogenizing layer is manufactured of copper, aluminum, silver or alloys thereof, preferably of copper.

If stainless steel or black steel is used for the tank wall and the inner casing, resp., and preferably also for the outer casing, and copper, aluminum, silver or alloys thereof are used for the temperature homogenizing layer, the heat conductivity of the temperature homogenizing layer can be ensured to be sufficiently higher than that of the tank wall.

Stainless steel has a heat conductivity of 21 W/mK, black steel has a heat conductivity of 50 W/mK, aluminum has a heat conductivity of 190 W/mK, copper has a heat conductivity of 400 W/mK and silver has a heat conductivity of 427 W/mK.

It is of particular advantage when each of the inner casing and the outer casing is made of stainless steel and the temperature homogenizing layer is made of copper.

When stainless steel is used for the inner casing and the tank wall, resp., sufficient scale resistance of the inner casing and the tank wall can be ensured. Stainless steel has a higher scale resistance than black steel. High scale resistance is crucial mainly in view of the high maximum temperatures. Scale is the solid product resulting from a reaction of a metal with its, specifically gaseous, environment at high temperature. Scaling results in the destruction of the metallic material. High scale resistance of a metal counteracts scaling of said metal. Further, the copper of the temperature homogenizing layer has such a positive effect on the stainless steel casing (inner and outer casings together) that the stainless steel casing does not warp due to its specifically temperature-homogenizing effect (which would happen in the case of large temperature variations or gradients). As compared to silver, copper is significantly cheaper and its heat conductivity is sufficient for the temperature-homogenizing effect of the temperature homogenizing layer. Although the heat conductivity of aluminum is sufficient for the temperature-homogenizing effect of the temperature homogenizing layer, the heat conductivity of copper is definitely better, however.

It is also advantageous when the gasifier insert (including the temperature homogenizing layer and the outer casing) is surrounded by a temperature insulating layer.

The temperature insulating layer intensifies the temperature-homogenizing effect of the temperature homogenizing layer.

It is further useful when the temperature insulating layer has a significantly lower heat conductivity than the tank wall, particularly a maximum heat conductivity of 0.04 W/mK.

When the temperature insulating layer has a significantly lower heat conductivity than the tank wall and in particular than the outer casing, it prevents the heat occurring in the gasifier tank from being dissipated to the environment.

Possibly, a higher output of the gasifier used is desired. The higher the desired output of the fixed bed gasifier, the larger the diameter, particularly the inner diameter, of the gasifier tank should be selected.

This simple correlation can help adapt the output of the fixed bed gasifier simply by adjusting the diameter of the gasifier tank.

The thickness of the temperature insulating layer can be provided to increase with an increasing diameter, particularly inner diameter, of the section of the tank wall of the gasifier tank, particularly the gasifier insert, which is surrounded by the temperature homogenizing layer; and the thickness of the temperature insulating layer can be provided to decrease with an increasing thickness of the temperature homogenizing layer.

In this way, it can be ensured that the temperature insulating layer always thermally insulates the gasifier tank sufficiently from the environment.

It is useful that, when the temperature homogenizing layer is manufactured of a material having a heat conductivity of at least 190 W/mK, preferably is manufactured of copper, at a diameter, particularly inner diameter, of the section of the tank wall of the gasifier tank surrounded by the temperature homogenizing layer of up to 600 mm, the thickness of the temperature homogenizing layer is between 3 mm and 5 mm, specifically 5 mm, and at a diameter, particularly inner diameter, of the section of the tank wall of the gasifier tank surrounded by the temperature homogenizing layer of equal to or more than 600 mm to 1000 mm, the thickness of the temperature homogenizing layer is between 5 mm and 7 mm, specifically at most 7 mm.

When the thickness of the (copper) temperature homogenizing layer is selected depending on the diameter of the section of the tank wall of the gasifier tank which is surrounded by the temperature homogenizing layer, it is ensured that the temperature homogenizing effect of the (copper) temperature homogenizing layer is safeguarded for each size of the fixed bed gasifier.

The following Table 1 illustrates the correlations between the diameter of the section of the tank wall of the gasifier tank which is surrounded by the temperature homogenizing layer (in simplified terms: section diameter), the thickness of the (copper) temperature homogenizing layer (in simplified terms: layer thickness) and the thickness of the temperature insulating layer (in simplified terms: insulating thickness):

TABLE 1

| | | Insulating thickness |
|---|---|---|
| Section diameter [mm] | Layer thickness [mm] | [mm] |
| ≤200 | 5 | 20 |
| ≤200 | 3 | 30 |
| 200-350 | 5 | 30 |
| 200-350 | 3 | 45 |
| 350-450 | 5 | 50 |
| 350-450 | 3 | 65 |
| 450-600 | 5 | 60 |
| 450-600 | 3 | 100 |
| 600-750 | 6 | 80 |
| 600-750 | 5 | 100 |
| 750-1000 | 7 | 140 |
| 750-1000 | 6 | 160 |

Moreover, it is useful when the tank wall which is made particularly of stainless steel and, resp., the inner casing has a wall thickness of 3 mm to 4 mm.

A tank wall of said material thickness is capable of sufficiently withstand mechanical loads occurring in the oxidation zone due to slagging. When the tank wall is thicker than 4 mm, such as 5 mm or more, the heat transmission into the temperature homogenizing layer is worse than in the case of the preferred tank wall thickness.

It is an advantageous aspect of the present disclosure that the gasifier tank includes a chute into which both the gasification agent supply and the fuel supply open and a gasifier insert or, resp., combustion chamber insert designed separately from the chute which includes the outlet for the discharge of slag and carbonaceous ash and producer and synthesis gas and forms the inner casing, the outer casing and the temperature homogenizing layer.

When the gasifier includes a gasifier insert that is designed separately from the chute, the gasifier insert can be easily replaced independently of the remaining fixed bed gasifier components. Moreover, the combination of the tank wall and the inner casing, resp., with the temperature homogenizing layer and, preferably, with the outer casing can be manufactured particularly easily in the form of a gasifier insert.

The gasifier insert and the chute are preferably thermally separated so that temperature homogenization has to be ensured only in the area and along the length of the gasifier insert.

Accordingly, it is useful when the gasifier insert is connected to a gasifier casing at least partially surrounding the gasifier tank, directly, i.e. without an intermediate element, or indirectly, such as through the chute, via a holder which is particularly a stable insulating plate.

### BRIEF DESCRIPTION OF THE DRAWINGS

FIG. 1 is a schematic longitudinal section view of a fixed bed gasifier;

FIG. 2 is a schematic longitudinal section view of a gasifier insert;

FIG. 3 is a schematic top view onto two rollers;

FIG. 4 is a schematic longitudinal section view of two rollers arranged side by side; and

FIG. 5 is a simplified schematic longitudinal section view of a fixed bed gasifier having more than two rollers.

### DETAILED DESCRIPTION

Hereinafter, aspects of the present disclosure shall be described on the basis of the related Figures. The shown aspects are merely exemplary and can be combined with each other, as far as this is technically useful.

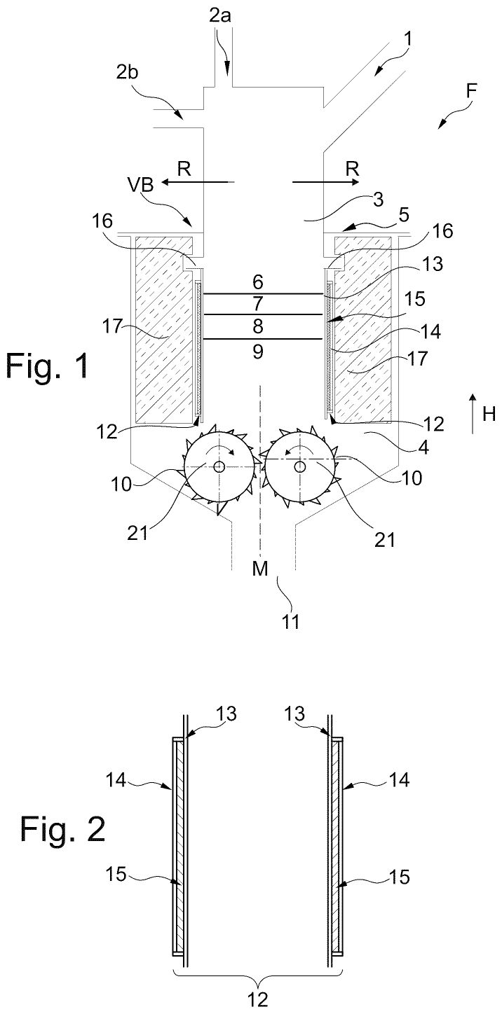

FIG. 1 is a schematic longitudinal section view of a fixed bed gasifier F. The fixed bed gasifier F described below is particularly suited to gasify slagging solid fuels, specifically waste materials, such as sewage sludge. The fixed bed gasifier F includes a gasifier tank VB. The gasifier tank VB includes, in its top section as seen in the axial direction or height direction H, a fuel supply 1 as well as a primary gasification agent supply 2a and a secondary gasification agent supply 2b. The (solid) fuel to be gasified, specifically slagging fuel, is supplied to the gasifier tank VB via the fuel supply 1. A gasification agent such as air, oxygen, steam or carbon dioxide is supplied to the gasifier tank VB of the fixed bed gasifier F via the gasification agent supplies 2a, 2b. The gasifier tank VB includes a chute 3 to the top section of which the fuel supply 1 and the gasification agent supplies 2a, 2b are attached in a height direction H. The chute 3 opens with its bottom section into a, specifically pressure-tight, gasifier casing 4. The chute 3 has a hollow-cylindrical design.

The primary gasification agent supply 2a is applied in each mode of operation of the fixed bed gasifier F. The secondary gasification agent supply 2b is applied when the system is run with oxygen and steam/carbon dioxide. The pressure-tight gasifier casing 4 has a substantially hollow-cylindrical design. On its upper side (top side of the gasifier casing 4 in the height direction H), the gasifier casing 4 has an opening 5 through which the chute 3 is connected to the gasifier casing 4. The upper part of the fixed bed gasifier F, i.e., the chute 3 with the fuel supply 1 and the primary gasification agent supply 2a as well as the secondary gasification agent supply 2b, forms a flange 5 and is flanged to the gasifier casing 4. The flanged connection between the upper part of the fixed bed gasifier F and the gasifier casing 4 is sealed gas-tightly to the environment so that no gas can escape from the fixed bed gasifier F between the upper part of the fixed bed gasifier F and the gasifier casing 4.

Different temperature zones 6 to 9 successive in the height direction H inside the gasifier casing 4 are provided in the gasifier tank VB that protrudes into the gasifier casing 4. The top temperature zone as viewed in the height direction H of the fixed bed gasifier F is the drying zone 6. At a drying temperature of about 100° C., the water contained in the fuel is evaporated here. The pyrolysis zone 7 in which the fuel is disintegrated at a pyrolysis temperature of up to 250° C. adjoins there beneath. The oxidation zone 8 in which carbon and hydrogen occurring in the fuel are oxidized into carbon dioxide and water at an oxidation temperature of up to 1700° C. (see above) adjoins beneath the pyrolysis zone 7. The reduction zone 9 as the bottom section of the gasifier tank VB in which the carbon dioxide and water obtained in the oxidation zone 6 are reduced at a reduction temperature ranging from 600° C. to 800° C. adjoins beneath the oxidation zone 8. After the reduction, the finished product, i.e., a producer or synthesis gas, is provided.

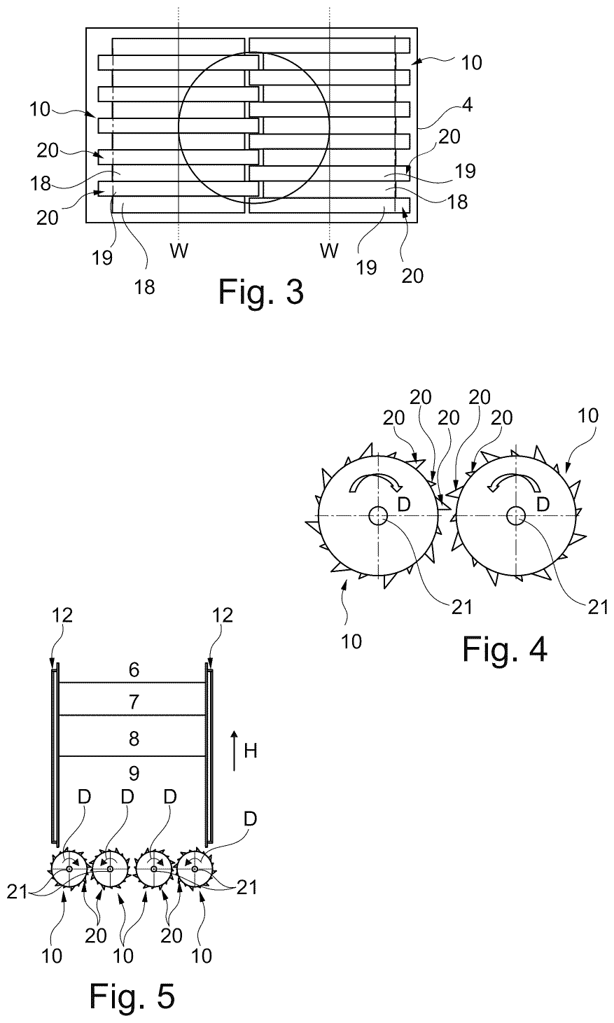

Carbonaceous ash and slag remain as a solid residue of the gasification in the temperature zones 6 to 9 in the fixed bed gasifier F. They are drained into the gasifier casing 4 through an outlet at the gasifier tank VB (bottom section of the gasifier tank VB in the height direction H) which is arranged inside the gasifier casing 4. In order to discharge said solid residues from the gasifier casing 4 and to guarantee homogenous bulk conditions in the gasifier casing 4, the solid residues are conveyed into an ash and gas flue 11 with the aid of at least two counterrotating rollers 10 (described in detail with respect to FIG. 3 to FIG. 5) which are arranged in a lower section (as viewed in the height direction H) of the gasifier casing 4. The gasifier casing 4 is conically tapered toward the ash and gas flue 11. The solid residues as well as the producer gas obtained are discharged from the fixed bed gasifier F through the ash and gas flue 11.

The section of the gasifier tank VB in which the temperature zones 6 to 9 are provided in this case is designed as a gasifier insert 12 formed separately from the chute 3. The gasifier insert 12 is arranged inside the gasifier casing 4 and extends in the height direction H. The gasifier insert 12, just as the chute 3, has a hollow cylinder shape. The diameter, specifically the inner diameter, of the gasifier insert 12 advantageously corresponds to the diameter, preferably the inner diameter, of the chute 3. The gasifier insert 12 limits the diameter of the temperature zones 6 to 9 to its own inner diameter.

The side of the gasifier insert 12 facing a central longitudinal axis M of the gasifier tank VB which forms at least a section of the tank wall of the gasifier tank VB is referred to as inner casing 13. The inner casing 13 is advantageously made of stainless steel. Together with an outer casing 14 that is spaced in parallel from the inner casing 13, the inner casing 13 encloses a temperature homogenizing layer 15. Advantageously, the outer casing 14 is also made of (stable) stainless steel. In particular, copper is used as temperature homogenizing layer 15. The copper ensures that the temperature is optimally distributed homogenously in the height direction H and in the circumferential direction of the gasifier tank VB.

The gasifier insert 12, and specifically the top section thereof in the height direction H, is connected to the chute 3, in particular to the bottom section thereof in the height direction H, by means of a holder 16. The holder 16 is a type of flange that is flanged to the gasifier insert. An insulating plate may be arranged as a sealing for the two flanges. The gasifier insert 12 is thermally insulated from the chute 3 by said insulating plate. Further, a temperature insulating layer 17 is provided between the outer casing 14 and the inner wall of the gasifier casing 14. The temperature insulating layer 17 intensifies the effect of the temperature homogenization and, resp., of the even distribution of the temperature inherent to the gasifier insert 12, and, thus, the decrease or suppression of temperature gradients inside the gasifier tank VB and, resp., the gasifier insert 12. The temperature insulating layer 17 is hollow-cylindrical and surrounds the gasifier insert 12 from outside.

FIG. 2 is a schematic longitudinal section view of the gasifier insert 12. It is clearly visible in which way the temperature homogenizing layer 15 is enclosed and, resp., encompassed by the inner casing 13 and the outer casing 14. The temperature homogenizing layer 15 can possibly melt or liquefy at extremely high temperatures (from about 1085° C. for copper). Since temperatures of up to 1700° C. occur in the fixed bed gasifier F, it may thus happen that the copper melts. Enclosing the temperature homogenizing layer 15 by the inner casing 13 and the outer casing 14 prevents the temperature homogenizing layer 15 from “flowing off”.

FIG. 3 is a schematic top view onto two engaging rollers 10 which are arranged in the gasifier casing 4, particularly directly, below the outlet of the gasifier tank VB. With the aid of the rollers 10, fine and coarse ash and slag particles are conveyed axially symmetrically and in proportion to a roller speed. The rollers 10 thus support smooth continuous operation of the fixed bed gasifier F and a gas of good quality (gas with little or no contamination). The center distance between the two rollers 10 corresponds at least to the diameter of the gasifier insert 12.

The rollers 10 are composed of a plurality of annular roller disks 18, 19. The annular roller disks 18, 19 are arranged successively along the roller longitudinal axis W and are connected for rotation and, resp., integrally with each other. Roller disks 18 having a plain outer periphery alternate with roller disks 19 having teeth 20 distributed over their outer periphery. The diameter of the roller disks 19 with teeth 20 is larger than that of the plain roller disks 18 by the teeth 20. The plain roller disks 18 of one roller 10 contact the respective roller disks 19 with teeth 20 of the other roller 10 arranged beside it. In this way, the two rollers 10 arranged side by side mutually clean each other. In so doing, at least one tooth 20 meshes with the corresponding tooth 20 of the adjacent roller 10 in the roller longitudinal direction.

FIG. 4 illustrates, just as FIG. 1, a longitudinal section view of two engaging and counterrotating rollers 10 which rotate toward each other at the top (on the side of the gasifier insert) and, thus, form a pair of rollers. The arrow D in the respective roller 10 indicates the direction of rotation thereof. It is evident that the rollers 10 rotate toward each other. Accordingly, the rollers 10 rotate away from the outlet of the gasifier tank VB (see FIG. 1). The teeth 20 of the interacting rollers 10 of one pair of rollers engage and mesh with each other. As a result, the teeth 20 catch and crush lump-shaped slag. The teeth 20 of one roller disk 19 are different in size and are divided into teeth 20 and smaller teeth 20 which are smaller than the teeth 20. Accordingly, the teeth 20 mutually alternate with the smaller teeth 20 over the outer periphery of the respective roller disk 19. The rollers 10 are arranged and aligned relative to each other so that each tooth 20 of one roller 10 meshes or interacts with a tooth 20 of the other roller 10 of the pair of rollers arranged beside it, and each smaller tooth 20 of the one roller 10 meshes or interacts with a smaller tooth 20 of the other roller 10 of the pair of rollers arranged beside it. In particular, the roller longitudinal axes W of the two rollers 10, 10 arranged side by side are parallel to each other. Moreover, the teeth 20 are arranged on the roller disks 19 spirally or helically relative to the respective roller longitudinal axis W. This has the effect that only one pair of teeth 20 of the pair of rollers is in mesh at a time. Advantageously, the drive power for the rollers 10 and the strain on a roller bearing can thus be minimized.

Furthermore, the rollers 10 can reach very high temperatures, as the ash and slag conveyed by them has temperatures of up to 1000° C. It is therefore necessary to cool the rollers 10. Accordingly, the rollers 10 are arranged on hollow shafts 21 for cooling. A coolant, particularly water or oil, flows through the hollow shafts 21 to cool the rollers 10. This type of cooling allows inexpensive and simple packings and bearings, specifically radial shaft seal rings, to be used in the fixed bed gasifier F. Advantageously, the coolant which flows past the hot rollers 10 for cooling and, thus, is heated can be used to dry the solid fuel. It is particularly useful to dry the solid fuel by means of the heat from the heated coolant outside the fixed bed gasifier F.

Taking the ratio of the center distance of the rollers to the inner diameter of the gasifier insert 12 into account, the fixed bed gasifier F can be scaled.

FIG. 5 is a simplified schematic longitudinal section view of the fixed bed gasifier F comprising four rollers 10 arranged side by side. For convenience, only the gasifier insert 12 as well as the temperature zones 6 to 9 occurring inside the gasifier insert 12 are shown here. Beneath the gasifier insert 12, four rollers 10 are arranged at one level in the height direction H. The center distance of the two outermost rollers 10 corresponds at least to the inner diameter of the gasifier insert 12. Each roller 10 counterrotates relative to the roller(s) 10 arranged next to it. Accordingly, each of the outer rollers 10 and the inner rollers 10 arranged directly next to it form a respective pair of rollers. In case that more than one pair of rollers is provided in the fixed bed gasifier F, the rollers 10 are smaller and have a larger distance from the oxidation zone 8 and, resp., from the reduction zone 9 than compared to a fixed bed gasifier F which includes one pair of rollers only. The rollers 10 of one pair of rollers rotate toward each other. The inner rollers 10 of each of the different pairs of rollers rotate away from each other. The rollers 10 are designed as illustrated in FIGS. 3 and 4 and are arranged so that the roller disks 18 without teeth of one roller in each case are opposite to the roller disks 19 with teeth of another (adjacent) counterrotating roller, and vice versa.

### LIST OF REFERENCE SIGNS

1 Fuel supply
2a primary gasification agent supply
2b secondary gasification agent supply
3 chute
4 gasifier casing
5 opening
6 drying zone
7 pyrolysis zone
8 oxidation zone
9 reduction zone
10 roller
11 ash and gas flue
12 gasifier insert
13 inner casing
14 outer casing
15 temperature homogenizing layer
16 holder
17 temperature insulating layer
18 plain roller disk
19 roller disk with teeth
20 teeth
21 hollow shaft
D direction of rotation of roller
F fixed bed gasifier
H height direction
M central axis of gasifier tank
R radial direction
VB gasifier tank
W roller longitudinal axis

1.-9. (canceled)

10. A fixed bed gasifier for generating a producer or synthesis gas from solid fuel, the fixed bed gasifier comprising:
a gasifier tank;
a fuel supply for supplying a solid fuel;
at least one gasification agent supply for supplying at least one gasification agent that is used to gasify the solid fuel provided in the gasifier tank;
an outlet for discharging slag and the producer or synthesis gas which result from gasification of the solid fuel; and
a temperature homogenizing layer surrounding at least a section of a tank wall of the gasifier tank,
the temperature homogenizing layer extending along the tank wall and having a heat conductivity higher than a heat conductivity of the tank wall, to ensure an even temperature distribution in the tank wall in an axial direction and a circumferential direction of the gasifier tank, and
the tank wall forming an inner casing which, together with an outer casing spaced apart from the inner casing, encloses the temperature homogenizing layer.

11. The fixed bed gasifier according to claim 10, wherein the solid fuel is gasified in the gasifier tank in different temperature zones successive in the axial direction, and the section of the tank wall extends at least over an area comprising the different temperature zones.

12. The fixed bed gasifier according to claim 11, wherein the different temperature zones include a drying zone, a pyrolysis zone, an oxidation zone and a reduction zone.

13. The fixed bed gasifier according to claim 10, wherein the tank wall is manufactured of stainless steel or black steel, and the temperature homogenizing layer is manufactured of a material having a heat conductivity of at least 190 W/mK.

14. The fixed bed gasifier according to claim 10, wherein the heat conductivity of the temperature homogenizing layer is higher than a heat conductivity of the inner casing and of the outer casing.

15. The fixed bed gasifier according to claim 14, wherein each of the inner casing and the outer casing is manufactured of stainless steel, and the temperature homogenizing layer is manufactured of copper.

16. The fixed bed gasifier according to claim 10, wherein the temperature homogenizing layer is surrounded by a temperature insulating layer.

17. The fixed bed gasifier according to claim 16, wherein the temperature insulating layer has a significantly lower heat conductivity than the tank wall.

18. The fixed bed gasifier according to claim 10, wherein:
the temperature homogenizing layer is made of a material having a heat conductivity of at least 190 W/mK,
the section of the tank wall has a diameter of up to 600 mm, and
the temperature homogenizing layer has a thickness between 3 mm and 5 mm.

19. The fixed bed gasifier according to claim 10, wherein:
the temperature homogenizing layer is made of a material having a heat conductivity of at least 190 W/mK,
the section of the tank wall has a diameter of between 600 mm and 1000 mm, and
the temperature homogenizing layer has a thickness between 5 mm and 7 mm.

20. The fixed bed gasifier according to claim 10, wherein the gasifier tank comprises:
a chute; and
a gasifier insert,
wherein the fuel supply and the at least one gasification agent supply open into the chute,
wherein the gasifier insert is separate and thermally separated from the chute, and
wherein the chute includes the outlet.

21. The fixed bed gasifier according to claim 20, further comprising a holder via which the gasifier insert is thermally insulated from the chute and/or via which the gasifier insert is connected to a gasifier casing at least partially surrounding the gasifier tank.

22. The fixed bed gasifier according to claim 21, wherein the inner casing and the outer casing form an annular passage in which the temperature homogenizing layer is received.

23. The fixed bed gasifier according to claim 10, wherein the inner casing is made of material, and the outer casing is also made of the material.

24. The fixed bed gasifier according to claim 10, wherein the inner casing is made of stainless steel.

25. The fixed bed gasifier according to claim 10, wherein the temperature homogenizing layer is manufactured of copper, aluminum, silver or alloys thereof.

26. The fixed bed gasifier according to claim 10, wherein the outer casing is surrounded by a temperature insulating layer.

27. The fixed bed gasifier according to claim 26, wherein the temperature insulating layer has a maximum heat conductivity of 0.04 W/mK.

28. The fixed bed gasifier according to claim 10, wherein the outer casing is spaced from the inner casing in a radial direction.
